(19) United States
(12) Patent Application Publication
(10) Pub. No.: US 2009/0116653 A1
(43) Pub. Date: May 7, 2009

(54) Audio signal processing device, audio signal processing method, program thereof, and recording meduim containing the program

(76) Inventors: Hajime Yoshino, Saitama (JP); Shintaro Hosoi, Saitama (JP)

Correspondence Address: KRATZ, QUINTOS & HANSON, LLP, 1420 K Street, N.W., Suite 400, WASHINGTON, DC, 20005, US

(21) Appl. No.: 11/988,688

(22) PCT Filed: May 17, 2006
(86) PCT No.: PCT/JP2006/309856

§ 371 Date: Mar. 14, 2008

(30) Foreign Application Priority Data
Jul. 11, 2005 (JP) 2005-202269

(51) Int. Cl. H04R 5/00

(52) U.S. Cl. 381/17

(57) ABSTRACT

Stream audio signals input in channel input terminals (710FL, 710FR) of a large setting are passed through large high-bandpass filters (720) arranged identically to small high-bandpass filters (740) for extracting high-frequency components from stream audio signals input in channel input terminals (710C, 710SL, 710SR, 710SBL, 710SRB) of a small setting. The stream audio signals are also passed through large low-bandpass filters (730) for extracting low-frequency components blocked by the large high-bandpass filters (720). The extracted high-frequency components and the extracted low-frequency components are added together by large adders (780) so as to be output. Phases of the stream audio signals in different settings can be matched, thereby contributing to favorable reproduction.

### TECHNICAL FIELD

The present invention relates to an audio-signal processor and an audio-signal processing method for processing audio signal to be reproducible by plural speakers, the program and a recording medium recording the program.

### BACKGROUND ART

Reproduction systems for reproducing multichannel audio using plural speakers have been conventionally known. An example of such reproduction systems displays image data on a monitor while reproducing audio signals by plural speakers disposed around a user, so that the audio signals are reproduced in a manner surrounding the user. As in, for instance, 5.1 channels or 7.1 channels, such audio signals as reproduced by the reproduction systems are processed for channels each corresponding to the speakers disposed around the user to be reproduced by the speakers.

Since such a reproduction system processes audio signals for each of the speakers that have been disposed at predetermined positions relative to an audiovisual reference point within a limited living space, speakers of different sizes may be used for convenience of installation. Specifically, as speakers to be disposed at both sides of a monitor in front of the user, relatively large speakers whose diaphragm radial dimensions are so large as to be capable of reproducing signals from low frequency to high frequency to a certain extent may be used. On the other hand, as speakers such as a central speaker (C-speaker) disposed below the monitor and a surround speaker (S-speaker) disposed behind the user, relatively small speakers may be used. Such relatively small speakers, which do not favorably output audio signals of certain low frequency, requires an audio-signal processing shown in FIG. 1, an example of which is a management function of a Dolby™. Specifically, according to such conventional audio-signal processing as shown in FIG. 1, audio signals of channels corresponding to relatively large speakers are output from output terminals 910 via input terminals 910 with no processing while audio signals of channels corresponding to relatively small speakers pass through high-bandpass filters (HPF) 920 for extracting high-frequency components when output from output terminals 911 via input terminals 902.

### DISCLOSURE OF THE INVENTION

### Problems to Be Solved by the Invention

However, since such a conventional bus management function as shown in FIG. 1 performs processing of two settings in a mixed manner: i.e., a so-called small setting for extracting high-frequency components in processing audio signals of channels corresponding to speakers that cannot favorably reproduce low-frequency components such as the relatively small speakers in order for the speakers to reproduce the signals; and a so-called large setting for outputting without extracting predetermined frequency component audio signals of channels corresponding to speakers that can relatively favorably reproduce low-frequency components such as the relatively large speakers in order for the speakers to reproduce the signals, there may arise a phase-mismatch between the audio signals output in the small setting and the audio signals output in the large setting. Due to the above problem, favorable reproduction may be hampered.

In view of such problems, an object of the present invention is to provide an audio-signal processor and an audio-signal processing method with which audio signals can be favorably reproduced even when a setting for extracting predetermined frequency components in outputting and a setting for outputting substantially the entire frequency components are employed in multiple channels in a mixed manner, and to provide the program and a recording medium storing the program.

### Means for Solving the Problems

An audio-signal processor according to one aspect of the present invention is an audio-signal processor that processes audio signals to be reproducible by plural speakers disposed around a reference point, the audio signals being audio signals of channels respectively corresponding to the speakers, the speakers reproducing the audio signals of the channels respectively corresponding to the speakers, the audio-signal processor including: an audio-signal acquirer that acquires audio signals of predetermined channels; a first filter that allows only passage of a first frequency substantially identical to a predetermined frequency and extracts a predetermined first frequency component from the acquired audio signals of the predetermined channels, the predetermined frequency being a frequency of an audio signal of a channel different from the predetermined channels, the predetermined frequency being the sole frequency whose passage is allowed by a specific filter; a second filter that allows passage of a second frequency of the acquired audio signals of the predetermined channels and extracts a predetermined second frequency component, the second frequency being a frequency that is blocked by the first filter; and an adder that adds the first frequency component and the second frequency component together and outputs the added components as an added signal in a manner reproducible by the speakers corresponding to the predetermined channels.

A method of processing audio signals according to another aspect of the present invention is a method of processing audio signals to be reproducible by plural speakers disposed around a reference point, the audio signals being audio signals of channels respectively corresponding to the speakers, the speakers reproducing the audio signals of the channels respectively corresponding to the speakers, the method including: extracting a predetermined first frequency component by passing acquired audio signals of predetermined channels through a first filter that allows only passage of a first frequency substantially identical to a predetermined frequency, the predetermined frequency being a frequency of an audio signal of a channel different from the predetermined channels, the predetermined frequency being the sole frequency whose passage is allowed by a specific filter; extracting a predetermined second frequency component by passing the acquired audio signals of the predetermined channels through a second filter that allows passage of a second frequency of the acquired audio signals of the predetermined channels, the second frequency being a frequency that is blocked by the first filter; and adding the first frequency component and the second frequency component together so as to output the added components as an added signal in a manner reproducible by the speakers corresponding to the predetermined channels.

An audio-signal processing program according to a further aspect of the present invention operates a computer as the above-described audio-signal processor of the present invention.

A recording medium according to a still further aspect of the present invention stores the above-described audio-signal processing program according to the present invention in a manner readable by a computer.

### BRIEF DESCRIPTION OF DRAWINGS

FIG. 1 is a block diagram schematically showing an arrangement of a bus management function according to a related art for explaining the present invention.

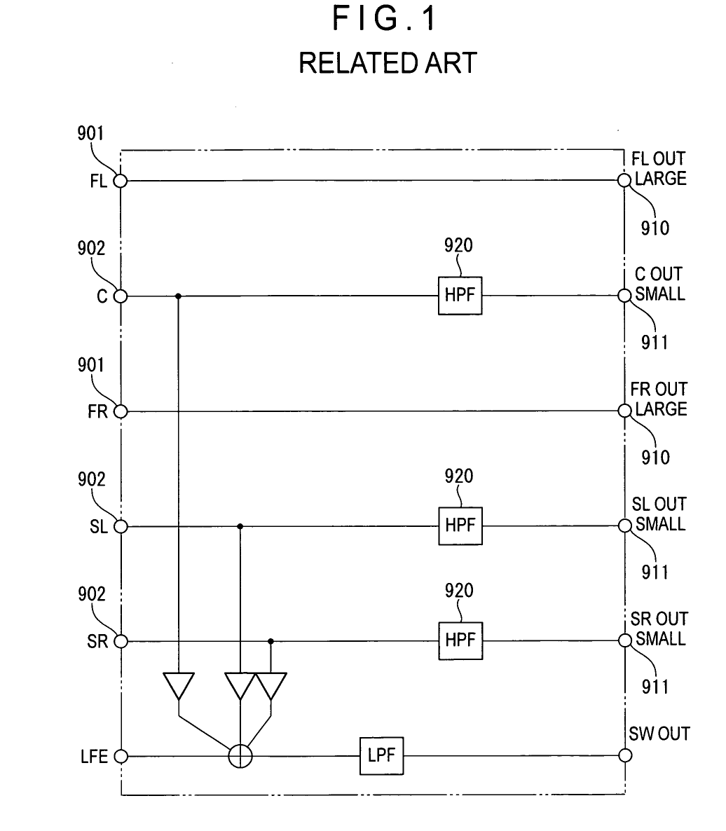

FIG. 2 is a block diagram schematically showing an arrangement of a reproducer according to a first embodiment of the present invention.

FIG. 3 is a block diagram schematically showing an arrangement of an audio signal processor configured as a program of a digital-signal processor in the reproducer according to the first embodiment of the present invention.

FIG. 4 is a block diagram schematically showing an arrangement of an audio signal processor configured as a program of a digital-signal processor in a reproducer according to a second embodiment of the present invention.

FIG. 5 is a block diagram schematically showing an arrangement of an audio signal processor configured as a program of a digital-signal processor in a reproducer according to a third embodiment of the present invention.

FIG. 6 is a block diagram schematically showing an arrangement of an audio signal processor configured as a program of a digital-signal processor in a reproducer according to a fourth embodiment of the present invention.

### EXPLANATION OF CODES

100 . . . reproducer

230 . . . speaker

230C . . . central speaker (speaker)

230FR . . . right front speaker (speaker)

230FL . . . left front speaker (speaker)

230SR . . . right rear speaker (speaker)

230SL . . . left rear speaker (speaker)

230SBR . . . right-rear surround speaker (speaker)

230SBL . . . left-rear surround speaker (speaker)

230LFE . . . bass sound speaker (speaker)

700 . . . audio signal processor

710 (710C, 710FL, 710FR, 710SL, 710SR, 710SBL, 710SBR) . . . channel input terminal as audio-signal acquirer

720 . . . large high-bandpass filter as first filter

730 . . . large low-bandpass filter as second filter

740 . . . small high-bandpass filter as specific filter

760 . . . low-bandpass filter as predetermined filter

770 . . . delay processor

780 . . . large adder as adder

### BEST MODE FOR CARRYING OUT THE INVENTION

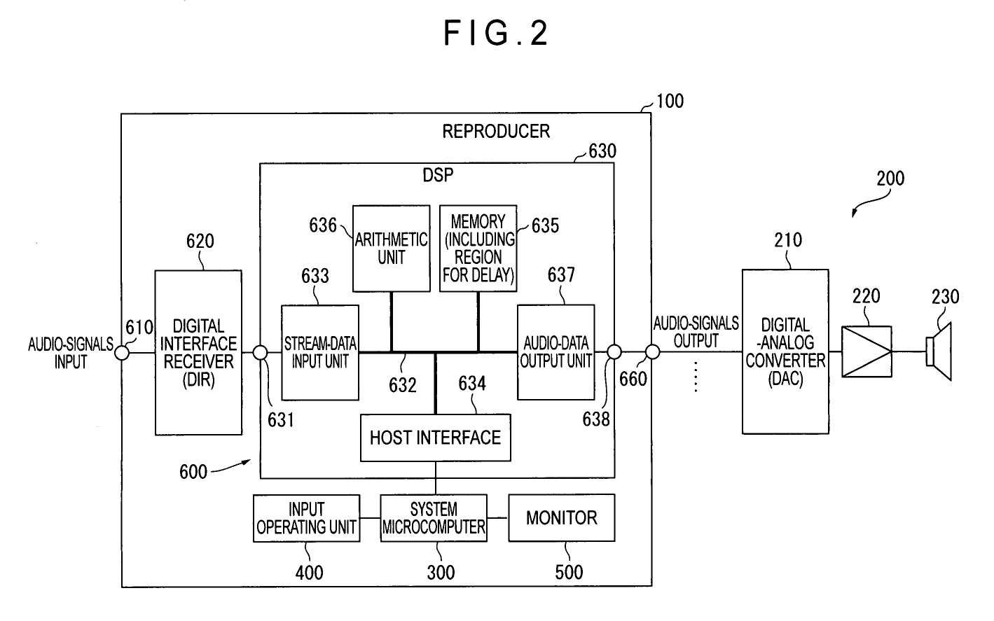

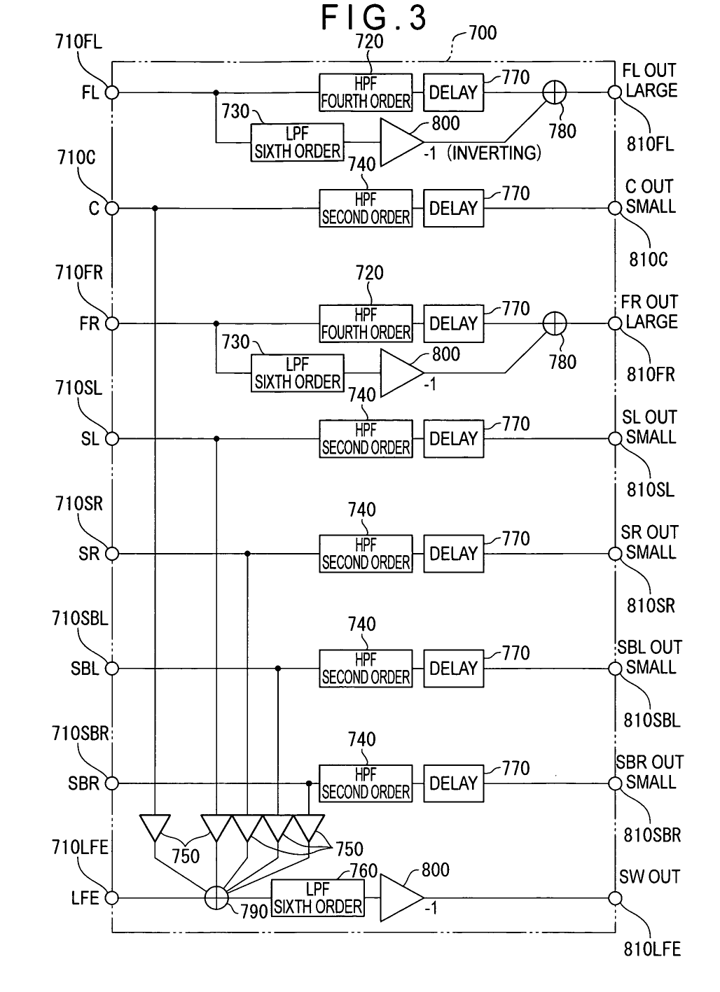

An embodiment of the present invention will be described below with reference to the attached drawings. Although a reproducer for reproducing and outputting audio signal is exemplified in the present embodiment, the present invention may be applied to an arrangement for processing image signal together with audio signal for reproduction, a so-called mixer for processing audio signal for reproduction or other arrangements. Additionally, although an arrangement for reproducing audio signal by a speaker is exemplified herein, the present invention may be applied to such an arrangement as to store processed audio signal in a recording medium or as to distribute such audio signal via network. The recording medium may be: an optical disk exemplified by a DVD (digital versatile disc), a CD (compact disc) or a hard disk; a magnetic disk; a magnetic tape; an audio track of a film; or a memory. Further, although an arrangement for processing digital audio signal is exemplified herein, the present invention may be applied to an arrangement for processing analog audio signal. FIG. 2 is a block diagram schematically showing an arrangement of a reproducer. FIG. 3 is a block diagram schematically showing an arrangement of an audio signal processor configured as a program of a digital-signal processor in the reproducer.

### [Arrangement of Reproducer]

In FIG. 2, the numeral 100 denotes a reproducer. The reproducer 100 processes audio signals and image signals so that a user can view the content. The reproducer 100 is connected with a plurality of output units 200 for reproducing the processed audio signals, i.e. outputting the processed audio signals as audio.

The output units 200 reproduce a variety of audio signals output from the reproducer 100. The output units 200 include digital-analog converters (DAC) 210, amplifiers 220 and speakers 230. The plural digital-analog converters 210, amplifiers 220 and speakers 230 may form eight pairs.

Note that the present embodiment will be described by exemplifying an arrangement in which the following 7.1-channel speakers are provided as the speakers 230 of the plural output units 200: a central speaker 230C disposed at an audiovisual position (reference point), specifically at a position substantially in front of a user who listens to the reproduced audio signals; a right front speaker 230FR disposed at a right front position relative to the user; a left front speaker 230FL disposed at a left front position relative to the user; a right rear speaker 230SR disposed at a right rear position relative to the user; a left rear speaker 230SL disposed at a left rear position relative to the user; a right-rear surround speaker 230SBR (a so-called surround speaker) disposed at a right rear position relative to the user; a left-rear surround speaker 230SBL (a so-called surround speaker) disposed at a left rear position relative to the user; and a bass sound speaker 230LFE for reproducing bass components (low frequency components) as low-frequency effects corresponding to 0.1 channel. The speakers may be 5.1-channel speakers in which the right-rear surround speaker 230SBR and the left-rear surround speaker 230SBL are omitted or 6.1-channel speakers that includes, in addition to the 5.1-channel speakers, one more speaker at a rear position relative to the user so as to substantially face the center speaker 230C.

Each DAC 210, which is connected to the reproducer 100, converts a digital audio signal processed and output by the reproducer 100 into an analog signal. Then, the DAC 210 outputs the analog-converted audio signal to a corresponding amplifier 220.

The amplifier 220 is connected to a corresponding speaker 230 as well as the corresponding DAC 210. The amplifier 220 processes the analog audio signal from the DAC 210 so that the corresponding speaker 230 can output the signal as necessary, and then outputs the signal to the speaker 230 for reproduction.

The reproducer 100 includes a system microcomputer 300, an input operating unit 400 (input unit), a monitor 500 and an audio processor 600. The system microcomputer 300 controls the entire operations of the reproducer 100. The system microcomputer 300 is connected with the input operating unit 400, the monitor 500 and the audio processor 600.

The input operating unit 400 has a plurality of switches such as operation buttons and operation knobs (not shown) to be used for input operations. The input operating unit 400 outputs a predetermined signal to the system microcomputer 300 by the input operations on the switches so as to input and set various conditions in the system microcomputer 300. The input operating unit may not necessarily input and set the conditions by the input operations on the switches but may employ any other suitable methods such as audio inputting. Alternatively, the input operating unit may be a remote controller that inputs and sets the conditions by transmitting signal corresponding to the input operations via a wireless medium in the system microcomputer 300.

As the monitor 500, various displays such as a liquid crystal panel or an electroluminescence panel may be used. The monitor 500 is controlled by the system microcomputer 300 to display a processing state of the audio signals, a reproducing and outputting condition, contents of the input operations and the like based on signal output from the system microcomputer 300.

The audio processor 600 is controlled by the system microcomputer 300 to process the audio signals so that the speakers 230 of the output units 200 can reproduce the signals as audio output. The audio processor 600 includes a plurality of audio-signal input terminals 610, a digital interface receiver (DIR) 620 that can also function as an audio-signal acquirer, a digital signal processor (DSP) 630 serving as an audio-signal processor (an arithmetic unit) and a plurality of (e.g. eight) audio-signal output terminals 660 the number of which corresponds to the number of the output units 200.

Each audio-signal input terminal 610 is a terminal to be connected with a connector or a lead wire to which a plug (not shown) is exemplarily detachably connected. The audio-signal input terminal 610 is detachably connected with an audio-signal outputting equipment for outputting an audio signal to receive input of the audio signal output from the equipment. In the audio-signal input terminal 610, such a digital audio signal as follows may be input: a digital audio signal converted by an analog-digital converter from analog audio signal output by an electric musical instrument (not shown); or a digital audio signal read from a recording medium (optical disk, magnetic disk, etc) by a drive of a reader as described above.

The DIR 620 is connected with the audio-signal input terminals 610. The DIR 620 acquires the audio signal input in the audio-signal input terminal 610 so as to perform a conversion on the signal as necessary and outputs the signal to the digital signal processor 630 connected to the DIR 620 as a stream audio signal.

Each audio-signal output terminal 660 is a terminal to be connected with a connector or a lead wire to which a plug is exemplarily connected. The audio-signal output terminals 660 are connected to the digital signal processor 630 while being connected to the DACs 210 of the output units 200 respectively. The number of the audio-signal output terminals 660 is plural so as to correspond to the number of the output units 200, such that each of the output units 200 can be connected to the corresponding audio-signal output terminal 660 via a lead wire. Then, the audio-signal output terminals 660 output the audio signals output from the digital signal processor 630 to the output units 200.

The DSP 630 is connected to the DIR 620, the audio-signal output terminals 660 and the system microcomputer 300. The digital signal processor 630 is controlled by the system microcomputer 300 to acquire the stream audio signals output from the DIR 620, perform as necessary mixing-processing, effect-processing and delay-processing on the acquired audio signals, and output the audio signals to the audio signal output terminals 660. The digital signal processor 630 includes plural input terminals 631 (audio-signal acquirer), a data bus 632, stream-data input unit 633, a host interface 634, a memory 635 (storage), an arithmetic unit 636, an audio-data output unit 637 and plural output terminals 638.

Each input terminal 631 is connected to the DIR 620 to receive input of the stream audio signal output from the DIR 620 corresponding to the audio signal input in each of the audio-signal input terminals 610. The plural input terminals 631, which correspond to the plural audio-signal input terminals 610, receive input of the stream audio signals processed and output by the DIR 620, the stream audio signals corresponding to the audio signals input in the audio signal input terminals 610 respectively.

The stream-data input unit 633 is connected to the input terminals 631 and the data bus 632. The stream-data input terminal 633 acquires the stream audio signals input in the input terminals 631 from the DIR 620 to output as necessary the acquired audio signals to the data bus 632.

The host interface 634 is connected to the system microcomputer 300 and the data bus 632. The host interface 634 outputs a command signal from the system microcomputer 300 to the arithmetic unit 636 via the data bus 632 to operate the arithmetic unit 636.

The audio-data output unit 637 is connected to the data bus 632 and the output terminals 638. The audio-data output unit 637 acquires from the data bus 632 the audio signals having been processed by the arithmetic unit 636 in the later-described manner to output as necessary the acquired audio signals to the output terminals 638.

The plural output terminals 638 correspond to the plural input terminals 631. The output terminals 638 output the stream audio signals input in the input terminals 631 and output from the audio-data output unit 637 as channel audio signals FL, FR, SL, SR, C, SBL, SBR and LFE (low frequency effect) respectively for the reproduction by the speakers 230 of the output units 200. Although the audio signal LFE corresponds to 0.1 channel in the so-called 7.1 channel, i.e., a channel that only includes the low frequency components (low frequency effects) to be reproduced by the bass sound speaker LFE, the bass sound speaker 230 LFE may be switched to be a channel that reproduces the audio signal as original without filtering the signal by predetermined frequency as do the other channels 230C, 230FR, 230FL, 230SR, 230SL and the like. Alternatively, the audio signal LFE may be added to the other audio signals FL, FR, SL, SR, C, SBL and SBR to be reproduced by the other speakers 230C, 230FR, 230FL, 230SR, 230SL, 230SBL and 230SBR. The details will be described later.

Although the output units 200, the audio-signal output terminals 660 and the output terminals 638 exemplarily process as necessary eight channel audio signals corresponding to the eight output units 200 and output the processed signals to the eight speakers 230 in the present embodiment, the number of the input terminals 631 and the number of the output terminals 638 may not necessarily correspond to each other to be paired but may be different from each other as in the above-described exemplary arrangement where the other 7 channel speakers reproduce the audio signal with the low-frequency components (low-frequency effects) instead of the bass sound speaker 230LFE.

The memory 635 may include a drive or a driver for storing and reading various data in and from a recording medium such as an optical disk, a magnetic disk or a memory card. Alternatively, the memory 635 itself may be configured to store and read such various data as does such a device as a semiconductor chip. The memory 635, which is connected to the data bus 632, stores a program for processing as necessary the stream audio signals, predetermined processing conditions for performing a delay-processing on the stream audio signals and the like. The memory 635 also includes an audio-signal storage region for exemplarily storing as necessary the stream audio signals.

The arithmetic unit 636, which is connected to the data bus 632, processes as necessary the stream audio signal output to the data bus 632 from the stream-data input unit 633 based on the command signal from the system microcomputer 300, and based on the program and the processing conditions stored in the memory 635.

The DSP 630 includes a controller, the audio-signal storage region of the memory 635 and a mixing-and-effect section (none of them is shown), which are all provided by the program stored in the memory 635. Specifically, the controller temporarily stores the stream audio signals input from the input terminals 631 in the audio-signal storage region, such that the mixing-and-effect section sorts the stream audio signals by the speakers 230. The mixing-and-effect section includes an output adjuster, an effecter and the audio signal processor 700 shown in FIG. 3.

The controller is connected to the memory 635, the input terminals 631 and the mixing-and-effect section. The controller acquires a synchronization signal input in any one of the input terminals 631 to temporarily store as necessary in the audio-signal storage section of the memory 635 the stream audio signals input in the other input terminals 631 based on the synchronization signal. The synchronization signal is a signal to synchronize the audio signals input in the audio-signal input terminals 610 by making the audio signals output at the same time, examples of which are reference pulse, internal clocks and the like.

Although a detailed description will be made later, the controller controls the mixing-and-effect section to perform as necessary delay-processing on the stream audio signals read from the audio-signal storage of the memory 635 based on the synchronization signal. For instance, synchronized with an arrangement for outputting images, the controller may perform such controls as to reproduce a predetermined audio signal(s) based on time information contained in the predetermined audio signal(s) when a predetermined image(s) is output, or to synchronize and reproduce the stream audio signals input in the audio-signal input terminals 610 based on time information contained in the stream audio signals.

By controlling the audio signal processor 700 with the controller, the system microcomputer 300 outputs a predetermined control signal(s) corresponding to the input operations exemplarily based on a signal(s) output corresponding to input operations on the operation buttons and the operation knobs of the input operating unit 400. The control signal(s) output from the system microcomputer 300 is recognized by the arithmetic unit 636 via the host interface 634 and the data bus 632, so that the controller (program) performs switching-control based on the control signal(s).

The output adjuster of the mixing-and-effect section, which is connected to the input terminals 631, acquires the stream audio signals input in the input terminals 631 and controls the acquired stream audio signals to be output by a predetermined output. Controlling of the output may be performed such that, exemplarily based on the signal(s) output corresponding to input operations on the operation buttons and the operation knobs of the input operating unit 400, the system microcomputer 300 outputs a control signal(s) corresponding to the input operations so as to adjust an output amount and an output volume to be output from the speakers 230. The control signal(s) output from the system microcomputer 300 is recognized by the arithmetic unit 636 via the host interface 634 and the data bus 632, so that the output adjuster (program) controls the output of the acquired stream audio signals based on the control signal(s).

The effecter of the mixing-and-effect section, which is connected to the output adjuster, performs effect-processing on the stream audio signals output from the output adjuster. Specifically, the effecter changes tones of the stream audio signals reproduced by the speakers 230 by changing frequencies or phases thereof, or add echo thereto, thereby changing phonetic quality. In the effecter, as described above, contents of the effect-processing are set based on the control signal(s) from the system microcomputer 300, the control signal(s) exemplarily corresponding to the input operations on the input operating unit 400. The effecter divides the effect-processed stream signals into a plurality (i.e., into eight corresponding to the channels to which the signals are destined) to output as necessary the divided stream signals to the audio-signal processor 700.

The audio signal processor 700 matches the phases of the audio signals corresponding to the channels of the output units 200 so as to output the signals to the output units 200. The audio-signal processor 700 includes: channel input terminals 710 (audio signal acquirer) the number of which corresponds to the number of the channels; large high-bandpass filters 720 as a first filter; large low-bandpass filters 730 as a second filter; small high-bandpass filters 740 as a specific filter; attenuators 750; low-bandpass filters 760 as a predetermined filter; delay processors 770; large adders (adder) 780; low-band adders 790; a phase inverter 800; channel output terminals 810 (output terminals 638); and the like. Exemplarily in the present embodiment, speakers with relatively large radial dimensions that can favorably output low frequencies are set to be connected to the reproducer as the left-front speaker 230FL and the right-front speaker 230FR (large setting) while speakers with relatively small radial dimensions that cannot favorably output low frequencies are set to be connected to the reproducer as the central speaker 230C, the right-rear speaker 230SR, the left-rear speaker 230SL, the right-rear surround speaker 230SBR, the left-rear surround speaker 230SBL (small setting). Additionally, settings of 7.1 channels for reproducing low frequency effects from the bass sound speaker LFE are exemplarily input by the input operations.

Each channel input terminal 710 is connected to each effecter so as to receive input of the stream audio signal having been divided to correspond to each channel and added together by the effecter. Specifically, the plural effecters divide the stream audio signals into eight channels corresponding to the speakers 230 and adds the audio signals of the same channel together. The signals are synchronized to be input in the channel input terminals 710 corresponding to the channels. The channel input terminals 710 are connected to switches (not shown) controlled by the controller so that low frequency effects are extracted. In FIG. 3, the channel input terminals 710FL, 710FR, which have been set in the large setting so as not to extract the low frequency effects, are not divided, i.e., the switches do not perform a control to divide the stream audio signals.

The channel input terminals 710C, 710SL, 710SR, 710SBL, 710SBR, which have been set in the small setting, are connected with small high-bandpass filters 740. The small high-bandpass filters 740, which are so to speak hi-pass filters (HPF), block frequencies of the input stream audio signals that are lower than predetermined frequencies to only pass high-frequency components (first frequency component) therethrough. The small high-bandpass filters 740 are set to be second-order. The small high-bandpass filters 740 are connected to the delay processors (delay) 770. The delay processors 770, a detail of which will be described later, perform delay-processing on the stream audio signals of high-frequency components extracted by the small high-bandpass filters 740 so that the stream audio signals of low-frequency components extracted as the low-frequency effects are synchronized with delays caused by extracting. Then, the stream audio signals having experienced delay-processing are output to the corresponding channel output terminals 810C, 810SL, 810SR, 810SBL, 810SBR.

The channel input terminals 710C, 710SL, 710SR, 710SBL, 710SBR are connected to attenuators 750 for adjusting output of the stream audio signals divided by the switches in order to extract the low-frequency effects. The attenuators 750 adjust as necessary output levels of the stream audio signals corresponding to the channels so that the output levels correspond to an output level set for the channel of the low-frequency effects. The attenuators 750 are connected to a low-band adder 790 that is connected to the channel input terminal 710LFE. The low-band adder 790 adds the stream audio signal input in the channel input terminal 710LFE with the stream audio signals whose output has been adjusted by the attenuators 750 so as to generate a low-frequency added signal. The low-band adder 790 is connected with the low-bandpass filter 760 as the predetermined filter. The low-bandpass filter 760, which is a so-called low-pass filter (LPF), blocks frequencies of the low-frequency added signal that are higher than a predetermined frequency to only pass low-frequency components of the low-frequency effects therethrough. The low-bandpass filter 760 is set so that its order is higher than the orders of the small high-bandpass filters 740 and the large high-bandpass filters 720, i.e., sixth order. The low-bandpass filter 760 is connected with the phase inverter 800 for inverting phases of the stream audio signal as low-frequency added signal of low-frequency components of low-frequency effects, so that the stream audio signal is output to the channel output terminal 810LFE.

The channel input terminals 710FL, 710FR, which have been set in the large setting, are connected with switches (not shown) controlled by the controller. The switches divide the input stream audio signals so as to extract the high-frequency components (first frequency component) and the low-frequency components (second frequency component). FIG. 3 shows only a state where the channel input terminals 710FL, 710FR having been set in the large setting are divided so as to process the stream audio signals for the large setting. The large high-bandpass filters 720 and the large low-bandpass filters (LPF) 730 are parallely-connected to the channel input terminals 710FL, 710FR. In other words, the large high-bandpass filters 720 are connected on the side of the high-frequency components divided by the switches while the large low-bandpass filters 730 are connected on the side of the divided low-frequency components.

The large low-bandpass filters 730 used for the low-frequency components in the large setting block frequencies of the input stream audio signals that are higher than predetermined frequencies to only pass the low-frequency components of the same frequency therethrough as does the low-bandpass filter 760 used for processing the stream audio signals for low-frequency effects. The large low-bandpass filters 730 are also set to be sixth order. The large low-bandpass filters 730 are connected with phase inverters 800 arranged identically to the inverter used for processing the stream audio signals for low-frequency effects. The phase inverters 800 invert phases of the stream audio signals of extracted low-frequency components.

On the other hand, the large high-bandpass filters 720 used for the high-frequency components in the large setting block frequencies of the input stream audio signals that are lower than predetermined frequencies to only pass the high-frequency components of the same frequency therethrough as does the small high-bandpass filters 740. Specifically, the large high-bandpass filters 720 are set to have properties to extract the high-frequency components, which are to be blocked by the large low-bandpass filters 730 used for the low-frequency components. Provided that speaker property of the center speaker 230C, the right-rear speaker 230SR, the left-rear speaker 230SL, the right-rear surround speaker 230SBR and the left-rear surround speaker 230SBL of the small setting is set to be second order, the large high-bandpass filters 720 are set to be fourth order, which is a sum of the second order of the small high-bandpass filters 740 and the second order of the speakers.

The large high-bandpass filters 720 are connected to the delay processors (delay) 770 as in the small setting. Specifically, since the large low-bandpass filters 730, which are arranged identically to the low-bandpass filter 760 for low-frequency effects, extracts the low-frequency components on the side of the low-frequency components in the large setting, the stream audio signals of the extracted low-frequency components are likewise delayed. Accordingly, when the stream audio signals are processed as low-frequency effects, the delay processors 770 perform the same delay-processing as do the delay processors used in the small setting. In other words, the delay processors perform processing of group-delay correction. As in the small setting, the delay processors perform delay-processing so that the signals are synchronized with a delay caused by extracting the stream audio signals of the low-frequency components of the low-frequency effects, such that the signals of the large setting match the stream audio signals for low-frequency effects and the stream audio signals of the small setting.

The delay processors 770 and the phase inverters 800 in the large setting are connected to large adders 780. The large adders 780 add the delay-processed stream audio signals on the side of the high-frequency components with the phase-inverted stream audio signals on the side of the low-frequency components so as to generate added signals. By the time of adding-process, phases of the stream audio signals of both the high-frequency components and the low-frequency components have been matched. The stream audio signals as added signals of the large setting are output to the connected channel output terminals 810FL, 810FR.

As described above, the streams audio signals output to the channel output terminals 810 are matched by the group-delay correction performed on the stream audio signal for the low-frequency effects and the channel stream audio signals output by the other speakers 230. In addition, the matching between the high-frequency components and the low-frequency components in the large setting and the matching between the large setting and the small setting are obtained. Specifically, the phases with which the stream audio signals for the low-frequency effect are output to the channel output terminal 810LFE, the phases with which the stream audio signals of the small setting are output to the channel output terminals 810C, 810SL, 810SR, 810SBL, 810SBR, and the phases with which the stream audio signals of the large setting are output to the channel output terminals 810FL, 810FR are matched. By such a matching, group-delay property at the time of space synthesis during reproduction is made flat, i.e., a relationship between the frequency and the group-delay becomes substantially constant relative to the frequency (flat) in synthesized properties of the speakers 230.

### [Operations of Reproducer]

Next, as operations of the reproducer 100, reproduction operations for reproducing the audio signals will be described. As the reproduction operations, reproduction operations when the reproducer is set as in FIG. 3 will be described. Specifically, reproduction operations when the left-front speaker 230FL and the right-front speaker 230SR are set in the large setting while the center speaker 230C, the right-rear speaker 230SR, the left-rear speaker 230SL, the right-rear surround speaker 230SBR, the left-rear surround speaker 230SBL are set in the small setting will be described.

The speakers 230 disposed at predetermined positions within a preset allowable range are connected to the audio-signal output terminals 660 of the reproducer 100 while an audio-signal outputting equipment (not shown) for outputting audio signal such as electronic instrument or a reader is connected to the audio-signal input terminal 610. When the reproducer 100 and the audio-signal outputting equipment are turned on in this state, the system microcomputer 300 recognizes various input conditions of the input operating unit 400 by a user.

Then, when the arithmetic unit 636, which recognizes reproduction conditions and settings, recognizes the setting shown in FIG. 3, the controller establishes a program arrangement of the audio signal processor 700 shown in FIG. 3 based on contents of the input operations. When audio signals are output from the audio-signal outputting equipment in this state, the audio signals are input in the audio-signal input terminals 610 of the reproducer 100. The audio signals input in the audio-signal input terminals 610 are converted as necessary into the stream audio signals by the DIR 620 to be output to the DSP 630. Using the plural input terminals 631 corresponding to the audio-signal input terminals 610, the DSP 630 receives the plural stream audio signals received by the audio-signal input terminals 610. Then, the stream audio signals received by the input terminals 631 experiences processing by the mixing-and-effect section as necessary to be output to the audio signal processor 700, where the stream audio signals are processed such that their phases are matched corresponding to the set and input channels.

Specifically, the audio signals, which are output from the audio-signal outputting equipment, are input in the audio-signal input terminals 610 of the reproducer 100 to be converted as necessary into the stream audio signals by the DIR 620 and output to the DSP 630. Using the plural input terminals 631 corresponding to the audio-signal input terminals 610, the DSP 630 receives the plural stream audio signals received by the audio-signal input terminals 610. Then, the stream audio signals received by the input terminals 631 experiences processing by the mixing-and-effect section. Specifically, the stream audio signals input in the input terminals 631 experiences output-level adjustment (volume control) by the output adjuster as is preset based on the control signal issued by the controller in accordance with the user's input operations on the input operating section. The volume-controlled stream audio signals further experiences as necessary effect-processing (conversion into predetermined audio quality) by the effect processor as is preset in accordance with the input operations on the input operating unit 400 to be divided corresponding to the channels. Then, the stream audio signals experiences adding-processing to be input in to the channel input terminals 710 corresponding to the channels of the audio signal processor 700.

The stream audio signals input in the channel input terminals 710C, 710SL, 710SR, 710SBL, 710SBR of the small setting are divided by the switches (not shown) controlled by the controller to be adjusted by the attenuators 750 so that the output levels of the stream audio signals having already experienced volume-control to correspond to the channels are adjusted to be an output level set for the low-frequency effects. The stream audio signals whose output levels are adjusted by the attenuators 750 are subsequently added with the stream audio signal input in the channel input terminal 710LFE by the low-band adder 790 to be output as a low-frequency added signal. The stream audio signal as the low-frequency added signal experiences elimination of the high-frequency components by passing through the low-bandpass filters 760 and phase inversion by the phase inverter 800 to be output to the channel output terminal 810LFE.

The stream audio signals that are input in the channel input terminals 710C, 710SL, 710SR, 710SBL, 710SBR of the small setting but are not divided experience elimination of the low-frequency components by passing through the small high-bandpass filters 740 and delay-processing by the delay processors 770. By the delay-processing, the stream audio signals are processed such that the relationship between the frequency and the group-delay becomes substantially constant relative to the frequency (i.e., group-delay property of the stream audio signals of the small setting and the stream audio signal of low-frequency effects output to the channel output terminal 810LFE is made flat). Then, the stream audio signals are output to the corresponding channel output terminals 810C, 810SL, 810SR, 810SBL, 810SBR.

The stream audio signals output in the channel input terminals 710FL, 710FR of the large setting are divided by the switches (not shown) controlled by the controller. Then, first divided stream audio signals experiences elimination of the high-frequency components by passing through the large low-bandpass filters 730 and phase inversion by the phase inverters 800. On the other hand, second divided stream audio signals experiences elimination of the low-frequency components by passing through the large high-bandpass filters 720 and delay-processing by the delay processors 770. The phases of the stream audio signals on the side of the low-frequency components on which the inverting-processing has been performed and the stream audio signal on the side of the high-frequency components on which the delay-processing has been performed are matched by the delay processors 770 as in the case where the group-delay property of the stream audio signal for the low-frequency effects and the stream audio signals of the small setting becomes flat. The stream audio signals on the side of the low-frequency components and the stream audio signals on the side of the high-frequency components are added together by the large adder 780 to be the added stream audio signals and output to the channel output terminals 810FL, 810FR.

The stream audio signals output to the channel output terminals 810 are further output to the audio-signal output terminals 660 to which the channel output terminals 810 are connected. The stream audio signals output from the audio-signal output terminals 660 to the DACs 210 of the output units 200 are converted as necessary into analog stream audio signals. The stream audio signals are further amplified by the amplifiers 220 to be output from the speakers 230 (i.e., reproduced from the speakers 230).

### [Advantages of Embodiments]

As described above, in the above embodiment, the stream audio signals input in the channel input terminals 710FL, 710FR of the large setting pass through the large high-bandpass filters 720 so as to extract the high-frequency components for each channel, the large high-bandpass filters 720 being arranged identically to the small high-bandpass filters 740 for extracting the high-frequency components from the stream audio signals input in the channel input terminals 710C, 710SL, 710SR, 710SBL, 710SBR of the small setting corresponding to the different channels. In addition, as per channel, the stream audio signals pass through the large low-bandpass filters 730 for extracting the low-frequency components blocked by the large high-bandpass filters 720, such that the extracted high-frequency components and the low-frequency components are added together by the large adders 780 to generate the added stream audio signals of the large setting. Then, the added stream audio signals are output to the corresponding channel output terminals 810FL, 810FR. Accordingly, since the stream audio signals of the large setting are processed in the same manner as in the processing where the high-frequency components are extracted from the stream audio signals of the different channels whose setting are different (small setting), the phases of the stream audio signals of the different settings can be matched, thereby contributing to favorable reproduction.

In a mixed setting where different settings such as the small setting for eliminating the low-frequency components (a processing to let the stream audio signals pass through the small high-bandpass filters 740) and the large setting that does not require elimination of the low-frequency components are used for outputting the audio signals, the high-frequency components corresponding to the small setting are extracted from the stream audio signals of the large setting while the low-frequency components to be blocked are extracted therefrom, such that the extracted high-frequency components and low-frequency components are added together, thereby facilitating suitable phase-matching of the stream audio signals of the different settings (i.e., the small setting and the large setting).

In addition, in order to extract the low-frequency components and the high-frequency components of the large setting, the stream audio signals are divided by the switches to be separately processed. With this arrangement, in order to match the phases between the large setting and the small setting, the low-frequency components and the high-frequency components can be easily extracted from the stream audio signals of the large setting.

Further, when processing corresponding to 0.1 channel is performed, the processing including: dividing the stream audio signals input in the channel input terminals 710C, 710SL, 710SR, 710SBL, 710SBR of the small setting in order to reproduce the low-frequency components to be blocked in the small setting as the low-frequency effects; adding the divided stream audio signals by the low-band adder 790 after the output levels are suitably adjusted; and inverting the phases by passing the stream audio signals through the low-bandpass filters 760, the delay-processing to make flat the group-delay property of the stream audio signal for the low-frequency effects and the stream audio signals of the small setting is performed by the delay processors 770 on the stream audio signals extracted in the small setting as the high-frequency components. Then, the same processing as the delay-processing is performed by the delay processors 770 also on the stream audio signals extracted in the large setting as the high-frequency components as in the small setting. With this arrangement, as is the group-delay property of the stream audio signal for the low-frequency effects and the stream audio signals of the small setting, the group-delay property of the stream audio signals of the large setting and the other stream audio signals can be made flat. Further, by performing a processing that includes; dividing the stream audio signals in the large setting so as to obtain phase-matching between the large setting and the small setting; and adding the stream audio signals after the low-frequency components and the high-frequency components are extracted, the group-delay property of the low-frequency components and the high-frequency components can also be concurrently obtained. Hence, favorable reproduction can be realized.

The large high-bandpass filters 720 in the large setting is fourth order, which is the sum of the order of the small high-bandpass filters 740 in the small setting and the order of the speakers 230 for reproducing the stream audio signals of the small setting. With this arrangement, the phases of the stream audio signals of the large setting and the stream audio signals of the small setting can be favorably matched, thereby contributing to further favorable reproduction.

The large low-bandpass filters 730 in the large setting are set to be the same order as the low-bandpass filter 760 used for processing the stream audio signal for low-frequency effects. With this arrangement, the group-delay property can be favorably made flat, thereby contributing to further favorable reproduction. In addition, the delay processors 770 used for processing the stream audio signals of the large setting can be arranged in the same manner as the delay processors 770 used for processing the stream audio signals of the small setting, thereby facilitating simplification of the arrangement.

Since the audio signal processor 700 is configured as a program exemplarily using CPU (central processing unit), the settings of the stream audio signals of predetermined channels, for instance, can be easily switched from the large setting to the small setting. Thus, when the large setting and the small setting are used in a mixed manner, the phases can be suitably matched, thereby facilitating not only realization of an arrangement to provide favorable reproduction but also expansion of utility thereof. Further, by recording the programs recorded on a recording medium in a manner readable by a computer and the like, the audio signal processor 700 can be easily provided and the program can be easily handled, thereby expanding the use thereof. The settings may be switched as desired. Thus, reproduction as desired can be easily provided, thereby enhancing versatility thereof. The arithmetic unit of the present invention may not necessarily be a single computer but may be a combination of plural computers connected over a network, an element(s) such as the CPU and the microcomputer or a circuit board on which a plurality of electronic parts are mounted.

### [Modifications of Embodiments]

The present invention is not limited to the above embodiments but may include modifications as long as an object of the present invention can be attained.

Although the above embodiments have been described by exemplifying 7.1 channels in which the channels that output the audio signals from the left-front speaker 230FL and the right-front speaker 230FR are set in the large setting while the channels that output the audio signals from the central speaker 230C, the right-rear speaker 230SR, the left-rear speaker 230SL, the right-rear surround speaker 230SBR and the left-rear surround speaker 230SBL are set in the small setting, the channels may be switched between the large setting and the small setting as necessary by inputting and setting via the input operations as described above. When the large setting and the small setting are used in a mixed manner, the low-frequency components and the high-frequency components may be extracted from the audio signals of the large setting to be added together as in the above-described embodiments. The channels may not necessarily be 7.1 channels.

Although the large setting and the small setting are described above, even when channels that extract predetermined frequency band using bandpass filters or the like to output audio signals and channels that output substantially the entire frequency band as in the large setting are exemplarily used in a mixed manner, the latter channels may perform such processing as described above that includes; extracting frequency band blocked by the former channels; and adding the extracted frequency band with the frequency band extracted by the former channels in order to output the audio signals. In addition, in order to extract the frequency band to be blocked by the former filters, the latter channels may divide the audio signals to extract a plurality of frequency bands. By adding the frequency bands, the latter channels can output substantially the entire frequency band.

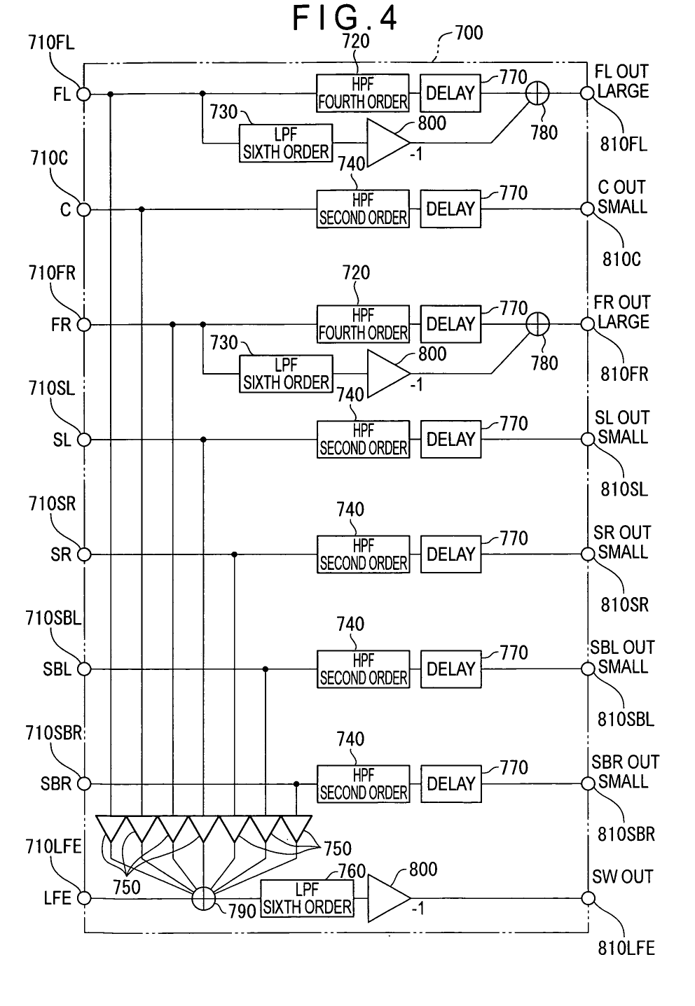

Although the stream audio signals of the small setting are divided and added as the low-frequency effects to be reproduced from the bass sound speaker 230LFE according to the above description, the stream audio signals of the large setting may also be divided and added as the low-frequency effects to be reproduced from the bass sound speaker 230LFE as is exemplarily shown in FIG. 4. In FIG. 4, the same components as in the embodiments shown in FIGS. 2 and 3 are denoted by the same numeral codes. Also in the arrangement shown in FIG. 4, even when different settings are used in a mixed manner, the phases can be matched, thereby contributing to favorable reproduction. In addition, the arrangement shown in FIG. 4 can provide greater low-frequency effects.

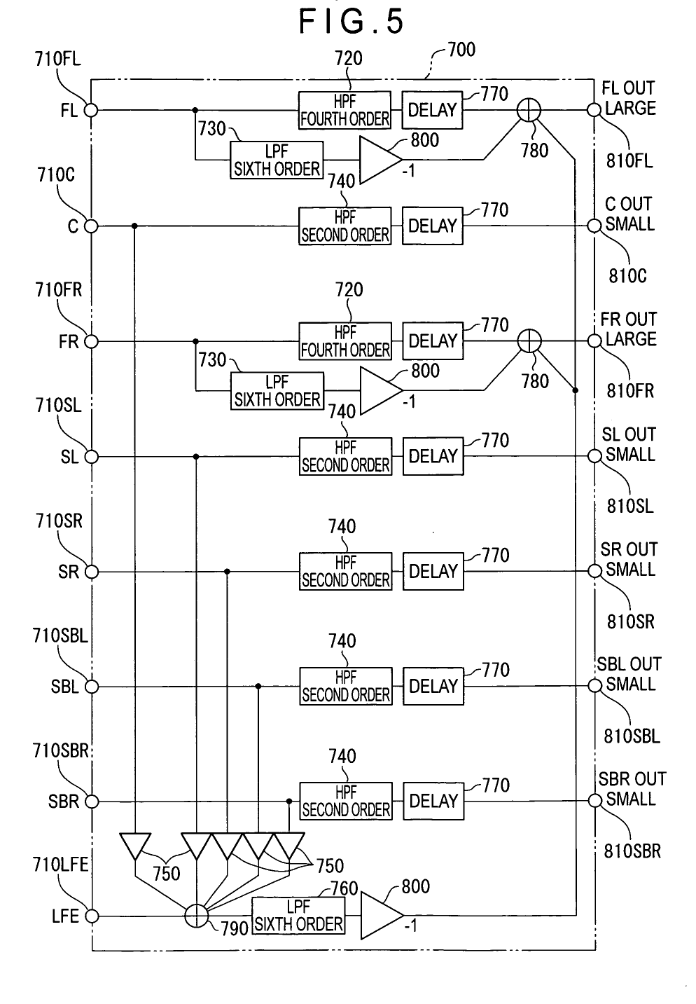

The channels may be set to be 7 channels as is exemplarily shown in FIG. 5. In FIG. 5, the same components as in the embodiments shown in FIGS. 2 and 3 are denoted by the same numeral codes. Specifically, the added signal processed as the stream audio signals for the low-frequency effects may be added with the stream audio signals of the channels corresponding to the left-front speaker 230FL and the right-front speaker 230FR (i.e., speakers capable of favorably reproducing the low-frequency components) so as to be output from the speakers 230FL, 230FR. More specifically, the large adder may add the stream audio signal (added signal) to the high-frequency components and the low-frequency components extracted from the stream audio signals of the large setting and output the added signals. Also in the arrangement shown in FIG. 5, even when different settings are used in a mixed manner, the phases can be matched, thereby contributing to favorable reproduction. Further, the arrangement shown in FIG. 5 does not require the bass sound speaker 230LFE, thereby easily simplifying the arrangement.

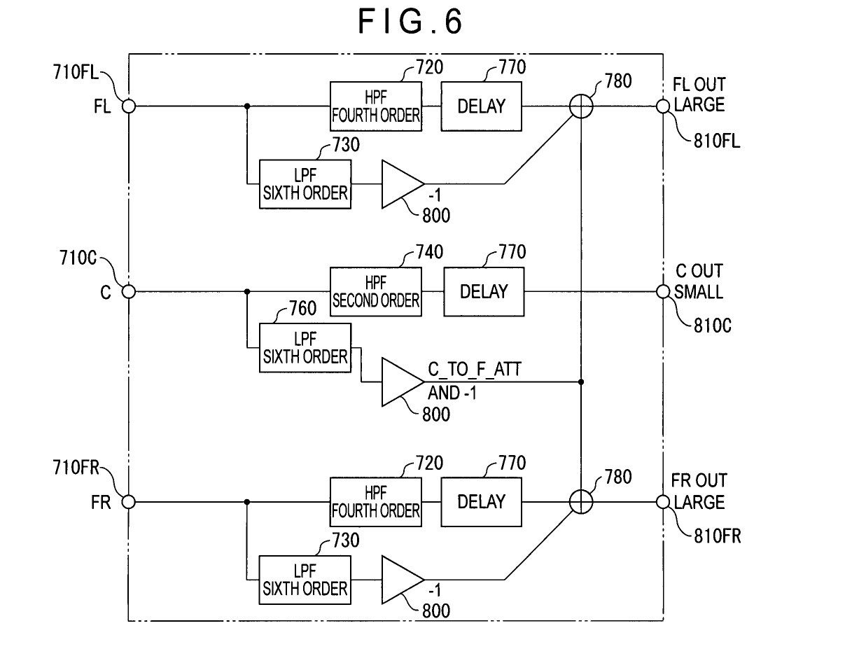

The channels may be set to be 3 channels as is exemplarily shown in FIG. 6. In FIG. 6, the same components as in the embodiments shown in FIGS. 2 and 3 are denoted by the same numeral codes. Specifically, the stream audio signal input in the channel input terminal 710C of the small setting is divided by a switch (not shown), so that the first divided stream audio signal passes through the small high-bandpass filter 740 and experiences delay-processing as in the above embodiments to be output to the channel output terminal 810. On the other hand, the second divided stream audio signal experiences elimination of the high-frequency components by passing through the low-bandpass filter 760 and phase-inversion by the phase inverter 800, so that its output level is adjusted from the preset output level of the central speaker 230C to the output levels of the left-front speaker 230FL and the right-front speaker 230FR to be output to the large adder 780 as the stream audio signal of the low-frequency components of low-frequency effects. The stream audio signal processed as low-frequency effects are subsequently added by the large adder 780 to the stream audio signals of the high-frequency components and the phase-inverted stream audio signals of the low-frequency components having been delay-processed by separate processing in the large setting. Then, the added stream audio signals are output to the channel output terminals 810FL, 810FR. Also in the arrangement shown in FIG. 6, even when different settings are used in a mixed manner, the phases can be matched, thereby contributing to favorable reproduction. In addition, the arrangement shown in FIG. 6 can provide greater low-frequency effects.

In the above-described embodiments, the order(s) may be set as desired. The delay-processing may be performed in accordance with property of filters that only allow passage of predetermined frequencies. For instance, the delay-processing in the large setting and the delay-processing in the small setting may be performed in different manners respectively. Further, in an exemplary arrangement that does not output low-frequency effects, the delay-processing may not be performed. The large high-bandpass filter(s) 720 may be the same order (e.g., second order) as the small high-bandpass filter(s) 740.

Although the reproduction conditions and the reproduction states are settable as desired by the setting of the input operations, reproduction conditions and reproduction states specifically designed for the arrangement(s) of the above-described embodiments may be employed.

Specific structures and operating procedures for implementing the present invention may be desirably modified as long as an object of the present invention can be achieved.

### [Effects of Embodiments]

As described above, the stream audio signals input in the channel input terminals 710FL, 710FR (predetermined channels) of the large setting pass through the large high-bandpass filters 720 so as to extract the high-frequency components, the large high-bandpass filters 720 being arranged identically to the small high-bandpass filters 740 for extracting the high-frequency components from the stream audio signals input in the channel input terminals 710C, 710SL, 710SR, 710SBL, 710SBR (different channels) of the small setting. In addition, the stream audio signals pass through the large low-bandpass filters 730 for extracting the low-frequency components blocked by the large high-bandpass filters 720, such that the extracted high-frequency components and the low-frequency components are added together by the large adders 780 to generate the added stream audio signals of the large setting and output. Accordingly, since the stream audio signals of the large setting are processed in the same manner as in the processing where the high-frequency components are extracted from the stream audio signals of the different channels whose setting are different (small setting), the phases of the stream audio signals of the different settings can be matched, thereby contributing to favorable reproduction.

### INDUSTRIAL APPLICABILITY

The present invention is applicable to an audio-signal processor and an audio-signal processing method for processing audio signal to be reproducible by plural speakers, the program and a recording medium recording the program.

1: An audio-signal processor that processes audio signals to be reproducible by plural speakers disposed around a reference point, the audio signals being audio signals of channels respectively corresponding to the speakers, the speakers reproducing the audio signals of the channels respectively corresponding to the speakers, the audio-signal processor comprising:
an audio-signal acquirer that acquires audio signals of predetermined channels;
a specific filter that allows only passage of a predetermined frequency of an audio signal of a channel that is different from the predetermined channel in a to-be-extracted frequency component;
a first filter that allows only passage of a first frequency substantially identical to the frequency passing the specific filter and extracts a predetermined first frequency component from the acquired audio signals of the predetermined channels;
a second filter that allows passage of a second frequency of the acquired audio signals of the predetermined channels and extracts a predetermined second frequency component, the second frequency being a frequency that is blocked by the first filter; and
an adder that adds the first frequency component and the second frequency component together and outputs the added components as an added signal in a manner reproducible by the speakers corresponding to the predetermined channels.

2: The audio-signal processor according to claim 1, wherein
an order of the first filter is set to be identical to a sum of an order of the predetermined speaker that outputs only the predetermined frequency and an order of the specific filter.

3: The audio-signal processor according to claim 1, further comprising
a delay processor that performs delay-processing on the first frequency component by an amount corresponding to a delay caused by an audio signal having passed a predetermined filter, the predetermined filter allowing only passage of a third frequency blocked by the specific filter from the audio signal of the channel different from the predetermined channels.

4: The audio-signal processor according to claim 3, wherein
the second filter allows only passage of a frequency substantially identical to the third frequency passing the predetermined filter, and an order of the second filter is set to be identical to an order of the predetermined filter.

5: The audio-signal processor according to claim 1, wherein
the first filter and the specific filter are high-bandpass filters that extract a high-frequency component from the acquired audio signals, and
the second filter is a low-bandpass filter that extracts a low-frequency component from the acquired audio signals.

6: A method of processing audio signals to be reproducible by plural speakers disposed around a reference point, the audio signals being audio signals of channels respectively corresponding to the speakers, the speakers reproducing the audio signals of the channels respectively corresponding to the speakers, the method comprising:
extracting a predetermined first frequency component by passing acquired audio signals of predetermined channels through a first filter that allows only passage of a first frequency substantially identical to a predetermined frequency, the predetermined frequency being a frequency of an audio signal of a channel that is different from the predetermined channels in a to-be-extracted frequency component, the predetermined frequency being the sole frequency whose passage is allowed by a specific filter;
extracting a predetermined second frequency component by passing the acquired audio signals of the predetermined channels through a second filter that allows passage of a second frequency of the acquired audio signals of the predetermined channels, the second frequency being a frequency that is blocked by the first filter; and
adding the first frequency component and the second frequency component together so as to output the added components as an added signal in a manner reproducible by the speakers corresponding to the predetermined channels.

7: An audio-signal processing program for operating a computer as the audio-signal processor according to claim 1.

8: A recording medium that stores the audio-signal processing program according to claim 7 in a manner readable by a computer.
